(19) United States
(12) Patent Application Publication
(10) Pub. No.: US 2009/0300209 A1
(43) Pub. Date: Dec. 3, 2009

(54) METHOD AND SYSTEM FOR PATH BASED NETWORK CONGESTION MANAGEMENT

(76) Inventor: Uri Elzur, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/477,680

(22) Filed: Jun. 3, 2009

Related U.S. Application Data
(60) Provisional application No. 61/058,309, filed on Jun. 3, 2008.

(51) Int. Cl. G06F 15/173; G06F 15/16

(52) U.S. Cl. 709/234; 709/242

(57) ABSTRACT

Aspects of a method and system for path based network congestion management are provided. In this regard, an indication of conditions, such as congestion, in a network may be utilized to determine which data flows may be affected by congestion in a network. A path table may be maintained to associate conditions in the network with flows affected by the conditions. Flows which are determined as being affected by a condition may be paused or flagged and transmission of data belonging to those flows may be deferred. Flows affected by a condition such as congestion may be identified based on a class of service with which they are associated. Transmission of one or more of the plurality of flows may be scheduled based on the determination. The determination may be based on one or both of a forwarding table and a forwarding algorithm of the downstream network device.

### CROSS-REFERENCE TO RELATED APPLICATIONS/INCORPORATION BY REFERENCE

This patent application makes reference to, claims priority to and claims benefit from U.S. Provisional Patent Application Ser. No. 61/058,309 filed on Jun. 3, 2008.

The above stated application is hereby incorporated herein by reference in its entirety.

### FIELD OF THE INVENTION

Certain embodiments of the invention relate to networking. More specifically, certain embodiments of the invention relate to a method and system for path based network congestion management.

### BACKGROUND OF THE INVENTION

In networks comprising data flows sharing resources, those network resources may occasionally be overburdened. Such overburdened resources may create congestion in a network leading to undesirable network delays and/or lost information.

Data from two data flows having different destinations may be queued in a common buffer in a first network device. In some instances, data from the first flow may not be transmitted due to congestion between the first network device and a destination device. In such instances, if data from the second data flow is queued behind the untransmittable data from the first data flow, then the data from the second data flow may also be prevented from being transmitted. Thus, in an attempt to alleviate congestion in a network, the second data flow, which otherwise would not have been impacted by the congestion, is undesirably halted. Such a condition is referred to as head of line blocking.

A potential solution to head of line blocking is to create separate buffers for each data flow. However, for large numbers of data flows, the amount of hardware buffers required would become prohibitively large and/or costly and software buffers would likely be too slow to respond to changing network conditions.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for path based network congestion management, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is diagram illustrating path based congestion management, in accordance with an embodiment of the invention.

FIGS. 2A and 2B are diagrams illustrating path based congestion management for a server generating multiple data flows, in accordance with an embodiment of the invention.

FIGS. 3A and 3B are diagrams illustrating path based congestion management for a server with virtualization, in accordance with an embodiment of the invention.

FIGS. 4A and 4B are diagrams illustrating path based congestion management over multiple network hops, in accordance with an embodiment of the invention.

FIG. 5 illustrates a portion of an exemplary path table that may be utilized for path based network congestion management, in accordance with an embodiment of the invention.

FIG. 6 is a flow chart illustrating exemplary steps for path based network congestion management, in accordance with an embodiment of the invention.

### DETAILED DESCRIPTION OF THE INVENTION

Certain embodiments of the invention may be found in a method and system for path based network congestion management. In various embodiments of the invention, an indication of conditions, such as congestion, in a network may be utilized to determine which data flows may be affected by the condition. Flows which are determined as being affected by the condition may be paused and data belonging to those flows may be removed from data buffers or flagged as associated with a congested path or flow. Flows affected by the condition may be identified based on various identifiers. Exemplary identifiers comprise media access control (MAC) level source address (SA) and destination address (DA) pair, or a 4-tuple or 5-tuple that corresponds to a flow level identification. The condition may occur in part of a network that supports wire priority. In such instances, the condition may affect a specific class of service and may be addressed as a problem affecting a class of service or multiple classes of service. The condition may also occur or on a network that only partially supports classes of service or not at all. Transmission of one or more of the plurality of flows may be scheduled based on the determination. The determination may be performed via a look-up table which may comprise information indicating which data flows are paused. The plurality of data flows may be generated by one or more virtual machines. The indication of the network condition may be received in one or more messages from a downstream network device. The determination may be based on one or both of a forwarding table and a forwarding algorithm of the downstream network device. A hash function utilized by the downstream device may be utilized for the determination. A look-up table utilized for the determination may be updated based on changes to a forwarding or routing table and/or an algorithm utilized by the downstream network device.

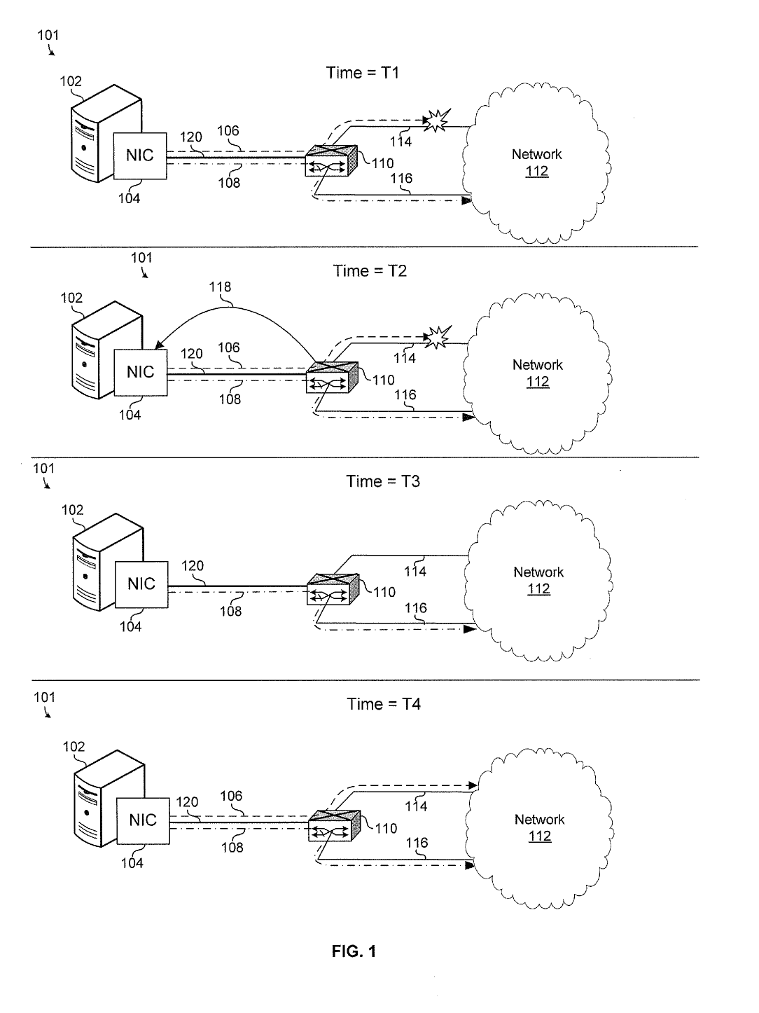

FIG. 1 is diagram illustrating path based congestion management, in accordance with an embodiment of the invention. Referring to FIG. 1 there is shown a network 101 comprising a server 102 coupled to a network interface card (NIC) 104, NIC uplink 120, a network switch 110, switch uplinks 114 and 116, and a remainder of the network 101 represented generically as sub-network 112.

The server 102 may comprise suitable logic, circuitry, interfaces, and/or code that may be operable to generate one or more data flows to be communicated via the network 101. In various exemplary embodiments of the invention, the server 102 may comprise a physical operating system and/or one or more virtual machines which may each be operable to generate one or more data flows. In various embodiments of the invention, the server 102 may run one or more processes or applications which may be operable to generate one or more data flows. Data flows generated by the server 102 may comprise voice, Internet data, and/or multimedia content. Multimedia content may comprise audio and/or visual content comprising, video, still images, animated images, and/or textual content.

The NIC 104 may comprise suitable logic, circuitry, interfaces, and/or code that may be operable to manage the transmission of data flows based on received condition indication messages (CIMs) and based on the NIC 104's knowledge of operation of the switch 110. A CIM may indicate conditions such as congestion encountered by one or more data flows. In this regard, the NIC 104 may be operable to queue and transmit each data flow based on conditions in the network 101 and each data flow's path through the network 101. The NIC 104 may be operable to store all or a portion of a forwarding table and/or forwarding algorithm utilized by the switch 110.

The NIC 104 may also be operable to store and/or maintain a path table, for example a look-up table or similar data structure, which may be utilized to identify portions of the network 101 that are traversed by each data flow. Each entry of the path table may also comprise a field indicating whether the data flow associated with the entry is paused or is okay to schedule for transmission.

The network switch 110 may comprise suitable logic, circuitry, interfaces, and/or code that may be operable to receive data via one or more network ports and forward the data via one or more network ports. The network switch 110 may comprise one or more forwarding tables for determining which links data should be forwarded onto to reach its destination. The forwarding table may utilize one or more hash functions for determining which links to forward data onto. Additionally, in various embodiments of the invention, the network switch 110 may be operable to detect conditions on one or more of uplinks to which it is communicatively coupled. For example, the switch 110 may determine an uplink is congested when transmit buffers associated with that uplink reach a threshold and/or reach some undesired rate of data accumulating in the buffers. Additionally and/or alternatively, the switch 110 may detect conditions, such as congestion, in a network by identifying one or more condition indication messages (CIMs), where the CIM(s) may be received from other down stream devices and may be targeted to an up-stream device—another switch or NIC, for example. Additionally and/or alternatively, the switch 110 may detect conditions, such as congestion, by transmitting test or control traffic onto its uplinks and awaiting responses from communication partners. Upon detecting conditions, such as congestion, on a switch uplink, the switch 110 may be operable to generate and transmit a condition indication message (CIM) 118 up stream, for example to the NIC 104.

The CIM 118 may comprise one or more packets and/or bits of data appended to, or inserted in, one or more packets. In some embodiments of the invention, the CIM 118 may be similar to an indication in a network utilizing quantized congestion notification (QCN) as specified by IEEE 802.1au. In this regard, the CIM 118 may comprise the source address and destination address of a data flow affected by a network condition. In other embodiments of the invention, the CIM 118 may also comprise a class of service of a data flow affected by a network condition, an egress port that originated a data flow affected by a network condition, and/or an egress port or uplink of the switch 110 on which a network condition, such as congestion or link failure, has been detected. Furthermore, the CIM 118 may comprise a time parameter which may indicate an amount of time to pause data flows which traverse portions of the network identified as being congested. The time parameter may be, for example, specified in terms of seconds, packet times, or number of packets.

The network uplink 120 and the switch uplinks 114 and 116 may each comprise a wired link utilizing protocols such as Ethernet, a wireless link utilizing protocols such as IEEE 802.11, or an optical link utilizing protocols such as PON or SONET.

The sub-network 112 may comprise any number of network links and/or devices such as computers, servers, switches, and routers. One or more devices within the sub-network 112 may receive data flows from a plurality of sources and/or may receive data at greater rate than it can process. Accordingly, one or more links coupled to the sub-network 112 may become congested.

In operation, the server 102 may generate data flows 106 and 108 and convey those data flows to the NIC 104. The NIC 104 may queue the data flows 106 and 108 and transmit them to the switch 110, when conditions in the network permit. The switch 110 may forward the data flow 106 onto the uplink 114 and the data flow 108 onto the uplink 116. At time instant T1, the switch 110 may detect congestion on the link 114. The switch 110 may detect the congestion based on, for example, a state of its transmit buffers, based on a CIM message, and/or by getting information about one or more delayed or lost packets from a downstream communication partner in the sub-network 112.

Subsequently, at time instant T2, the switch 110 may send a congestion indication message (CIM) 118 to the NIC 104. The CIM 118 may be communicated to the NIC 104 in-band and/or out-of band. In this regard, in-band may refer to the switch 110 communicating the CIM 118 along with ACK or other response packets associated with the data flow 106. Out-of-band may refer to, for example, dedicated management packets comprising the CIM 118 conveyed from the switch 110 to the NIC 104, and/or a communication channel and/or bandwidth reserved between the switch 110 and/or 104 for the communication of CIMs.

At time instant T3, the NIC 104 may process the CIM 118 and determine which data flows may be affected by the congestion. In an exemplary embodiment of the invention, the CIM 118 may comprise a source address and destination address of the affected data flow. Based on the source address and destination address, the NIC 104 may utilize its knowledge of the forwarding tables and/or algorithms utilized by the switch 110 to determine the paths or portions of the network affected by the congestion. The NIC 104 may periodically query the switch 110 to determine whether there has been any change or updates to the forwarding table and/or algorithm. Alternatively, the switch 110 may notify the NIC 104 anytime there is a change to the forwarding or routing table and/or algorithm. In this manner, the NIC 104's knowledge of the switch 110 may remain up-to-date. The NIC 104 may utilize its path table to determine which data flows traverse the congested portion of the network. The path table may be updated as new CIMs are received and as timers expire allowing data flows to again be scheduled for transmission. Thus, utilizing its knowledge of the switch 110's forwarding or routing table(s) and/or algorithm(s), and utilizing its own path table, the NIC 104 may map the CIM 118 to a particular path or portion of a network that is congested and consequently map it to data flows that traverse the congested portion of the network.

In another exemplary embodiment of the invention, the CIM 118 may indicate one or more characteristics of a data flow which has encountered network congestion. Exemplary characteristics may comprise class of service of the data flow, an uplink or egress port of the switch 110 on which the congestion was detected, and/or an egress port of the NIC 104 via which the affected data flow was received. In such an embodiment, the NIC 104 may determine that the data flow 106 has such characteristics. Accordingly, the NIC 104 may pause the data flow 106, slow down the data flow 106, and/or stop scheduling transmission of the data flow 106. Additionally, the NIC 104 may clear any packets of the data flow 106 from its transmit buffers or the NIC 104 may mark or flag packets of the data flow 106 that are already in a transmit buffer. Marking of data flow 106 packets in the transmit buffer(s) may enable skipping transmission of the packets. In this regard, when data is cleared from the transmit buffers, the NIC 104 may update one or more state registers. That is, rather than losing the dropped data, one or more state machines and/or processes may effectively be “rewound” such that it appears as if the data had never been transmitted or queued for transmission.

Additionally, in instances that other flows handled by the NIC 104 also have the identified characteristics, the NIC 104 may pause those data flows, slow down those data flows, avoid scheduling those data flows for transmission, and either clear packets of those data flows from the transmit buffers or mark packets of those data flows that are already buffered. In other words, a CIM pertaining to one particular flow may be generalized within the NIC 104 to control scheduling and transmission of other flows that also traverse the congested portion of the network 101. Furthermore, the CIM 118 may indicate the amount of time data flows destined for the congested portion of the network are to be paused. In some embodiments of the invention, the NIC 104 may dedicate more of its resources for transmitting the data flow 108 while the data flow 106 is paused, while the data flow 106 is slowed down, or while transmission of the data flow 106 is unscheduled. In this regard, the NIC 104 may determine a path over which the data flow 106 is to be transmitted; the NIC 104 may determine or estimate a time interval during which the path will be congested, slowed down, or subject to any other condition (e.g. not receiving a response to an earlier request) that indicates a slow down in servicing requests on that path; and the NIC 104 may pause, slow down, or not schedule transmission of the data flow 106 during the determined or estimated time interval. In this manner, scheduling of the data flows 106 and 108 for transmission may be based on conditions in the network 101, such as whether there is congestion or a link or device has failed.

At time instant T4, the congestion in the network may be gone and/or the amount of time the data flow 106 was to be paused, slowed down, or not scheduled for transmission may be complete. Accordingly, the NIC 104 may again begin queuing packets of the data flow 106 for transmission onto the link 120. In some embodiments of the invention, the rate at which data flow 106 is transmitted may be ramped up. The NIC 104 may update its path table to indicate that its view of the network assumes the condition on that path has cleared out.

Thus, the NIC 104 may be operable to make intelligent decisions regarding scheduling and transmission of data flows based on information known about conditions in the network 101 and the operation of the switch 110.

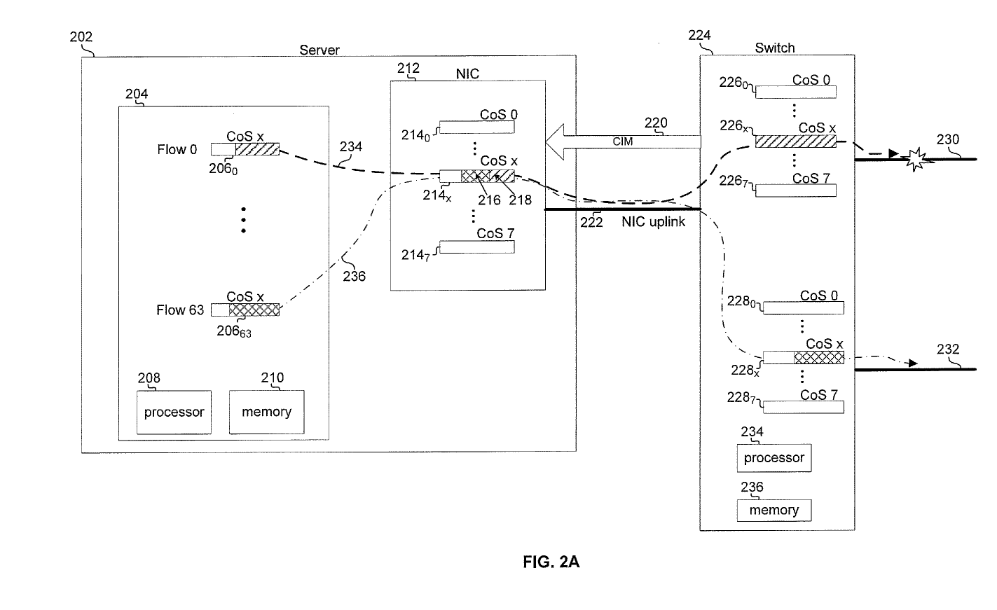

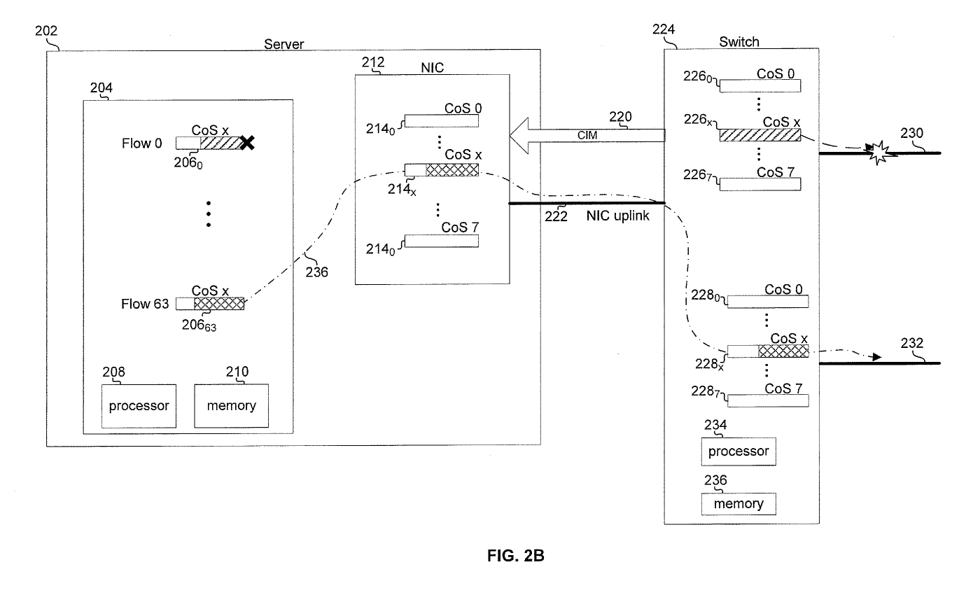

FIGS. 2A and 2B are diagrams illustrating path based congestion management for a server generating multiple data flows, in accordance with an embodiment of the invention. Referring to FIGS. 2A there is shown a server 202, a NIC 212, and a network switch 224. The NIC 212 may be communicatively coupled to the switch 224 via a NIC uplink 222.

The processing subsystem 204 may comprise a plurality of software buffers 206₀, . . . , 206₆₃, collectively referenced as buffers 206, a processor 208, and a memory 210. In this regard, the various components of the processing subsystem 204 are shown separately to illustrate functionality; however, various components of the server 202 may be implemented in any combination of shared or dedicated hardware, software, and/or firmware. For example, the buffers 206 and the memory 210 may physically comprise portions of the same memory, or may be implemented in separate memories. The NIC 212 may store control information (e.g. consumer and producer indices, queue statistics) or use the memory 210 to store these parameters or a subset of them. Although sixty-four buffers 206 are illustrated, the invention is not limited with regard to the number of buffers 206.

The processor 208 and the memory 210 may comprise suitable logic, circuitry, interfaces and/or code that may enable processing data and/or controlling operations of the server 202. The processor 202 may enable generating data flows which may be transmitted to remote communication partners via the NIC 212. In this regard, the processor 202, utilizing the memory 210, may execute applications, programs, and/or code which may generate data flows. Additionally, the processor 208, utilizing the memory 210, may be operable to run an operating system, implement hypervisor functions, and/or otherwise manage operation of various functions performed by the server 202. In this regard, the processor 208, utilizing the memory 210, may provide control signals to various components of the server 202 and control data transfers between various components of the server 202.

The buffers 206 may be realized in memory subsystem 210 and/or in shared memory and may be managed via software. In an exemplary embodiment of the invention, there may be a buffer 206 for each data flow generated by the server 202. In an exemplary embodiment of the invention, the server 202 may support sixty-four simultaneous data flows. However, the invention is not limited in number of flows supported.

The NIC 212 may be substantially similar to the NIC 104 described with respect to FIG. 1. The NIC 212 may comprise hardware buffers 214₀, . . . , 214_{M}, collectively referenced as hardware buffers 214. The hardware buffers 214 may be, for example, realized in dedicated SRAM. In some embodiments of the invention, the number ‘M’ of hardware buffers 214 may correspond to the number of classes of service supported by the uplink 222 and the switch 224. In such embodiments, each buffer 214 may be designated or allocated for buffering data flows associated with a single class of service (CoS). In other embodiments of the invention, there may be fewer buffers than classes of service, and single buffer 214 may be designated or allocated for storing data flows associated with multiple classes of service. The NIC 212 may also share the management of these buffers 206 with the processor 208. For example, the NIC 212 may store control information about the buffers 214 on the NIC 212 and/or store portion or all data on the NIC 212.

The NIC uplink 222 may be substantially similar to the uplink 120 described with respect to FIG. 1.

The switch 224 may be substantially similar to the switch 110 described with respect to FIG. 1. The exemplary switch 224 may comprise a processor 234, memory 236, buffers 226₀, . . . , 226₇, collectively referenced as buffers 226, and buffers 228₀, . . . , 228₇, collectively referenced as buffers 228.

The processor 234 and the memory 236 may comprise suitable logic, circuitry, interfaces and/or code that may enable processing data and/or controlling operations of the switch 224. The processor 234, utilizing the memory 236, and/or other dedicated logic (not shown), may enable parsing and/or otherwise processing ingress data to determine which uplink to forward the data onto. In this regard, the memory 236 may store one or more forwarding tables and/or algorithms and the processor 234 may write and read data to and from the table and/or implement the algorithm. Additionally, the processor 234, utilizing the memory 236, may be operable to run an operating system and/or otherwise manage forwarding of data by the switch 224. In this regard, the processor 234, utilizing the memory 236, or other hardware (not shown) may provide control signals to various components of the switch 224, generate control traffic such as CIMs, and control data transfers between various components of the switch 224.

The buffers 226 and 228 may be hardware buffers realized in, for example, dedicated SRAM or DRAM. In various embodiments of the invention, the number of hardware buffers 226 may correspond to the number of classes of service supported by the uplink 230 and the number of hardware buffers 228 may correspond to the number of classes of service supported by the uplink 232.

In operation, the server 202 may generate data flows 234 and 236. The data flows 234 and 236 may each have a CoS or wire level priority of ‘x,’ where ‘x’ may be, for example, from 0 to 7. In this regard, although 8 classes of service are utilized for illustration, the invention is not restricted to any particular number of classes of service. Also, aspects of the invention may be utilized even when no class of service is used, such as when PAUSE signals are utilized to control the flow of frames between the NIC 212 and the switch 224.

A network path of the data flow 234 may comprise the NIC uplink 222, the switch 224, and the switch uplink 230. In this regard, data of data flow 234 may be queued in buffer 206₀ for conveyance to the NIC 212. The invention is not so limited to prevent some data or all of the data associated with buffer 206₀ to be stored on the NIC. In the NIC 212, the data of data flow 234 may be queued in buffer 214ₓ for transmission to the switch 224. In the switch 224, the data of data flow 234 may be queued in buffer 226ₓ for transmission onto the switch uplink 230.

A network path of the data flow 236 may comprise the NIC uplink 222, the switch 224, and the switch uplink 232. In this regard, data of data flow 236 may be queued in buffer 206₆₃ for conveyance to the NIC 212. The invention is not so limited to prevent some data or all of the data associated with buffer 206₆₃ to be stored on the NIC. In the NIC 212, the data of data flow 236 may be queued in buffer 214ₓ for transmission to the switch 224. In the switch 224, the data of data flow 234 may be queued in buffer 228ₓ for transmission onto the switch uplink 232.

During operation, there may be congestion on the switch uplink 230 which may eventually cause the buffer 226ₓ to become full. In a conventional system, this would prevent the data 218 belonging to data flow 234 from being transmitted from the NIC 212 to the switch 224. Consequently, the data 216, belonging to the data flow 236, queued behind the data 218, may also be prevented from being transmitted. Thus, head of line blocking would occur and prevent the data flow 236 from being transmitted even though there is no congestion on the switch uplink 232 and no reason that the data flow 236 could not otherwise be successfully transmitted along its network path. Accordingly, aspects of the invention may prevent the congestion on the uplink 230 from blocking transmission of the data flow 236.

In an exemplary embodiment of the invention, data of the data flow 234 may get backed up and eventually cause the buffer 226ₓ to reach a “buffer full” threshold. Upon detecting the buffer 226ₓ reaching such a threshold, the switch 224 may transmit a congestion indication message (CIM) 220 to the NIC 212. The CIM 220 may indicate that there is congestion on the switch uplink 230 for class of service ‘x.’ Upon receiving the CIM 220, the NIC 212 may utilized its knowledge of the switch 224's routing algorithms and/or tables to determine which data flows have a path that comprises the uplink 230. In this manner, the NIC 212 may determine that the path of data flow 234 comprises switch uplink 230. Accordingly, in some embodiments of the invention, the NIC 212 may pause transmission of the data flow 234 and may clear the data 218 from the buffer 214ₓ so that the data 216, and subsequent data of the data flow 236, may be transmitted to the switch 224. In other embodiments of the invention, the NIC 212 may mark the data 218 as not ready to be transmitted, thus allowing other data to by-pass it. To pause the data flow 234, the NIC 212 may stop fetching data from the buffer 206₀ and convey one or more control signals and/or control messages to the processing subsystem 204. FIG. 2B illustrates the elimination of the head of line blocking in the buffer 214ₓ and the successful transmission of the data flow 236 after the data flow 234 has been paused and the data 218 cleared from the buffer 214ₓ.

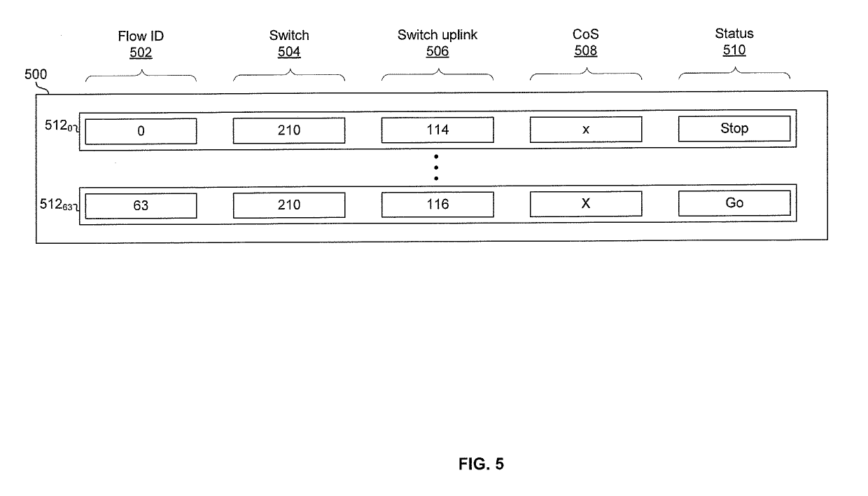

Additionally, still referring to FIGS. 2A and 2B, pausing of the data flow 234 may comprise updating one or more fields of a path table, such as the path table 500 described below with respect to FIG. 5. In this regard, when a CIM is received by the NIC 212, the NIC 212 may determine data flows impacted by the congestion and may update the path table to indicate that the data flows are paused, or are to be transmitted at a reduced rate. When the processor subsystem 204 desires to schedule the transmission of data associated with an existing data flow, the NIC 212 may consult its path table to determine whether the data flow is okay to transmit or whether it is paused. Similarly, when the processor subsystem 204 desires to schedule the transmission of data associated with a new data flow, the NIC 212 may first determine, utilizing routing algorithms and/or tables of the switch 224, a path of the data flow and then may consult its path table to determine whether the path comprises any congested links or devices.

In various embodiments of the invention, the server 202 may generate more than one data flow that traverses the switch uplink 230. In such instances, each flow that traverses the switch uplink 230, and is of an affected class of service, may be paused and/or rescheduled and may be either removed from a transmit buffer or marked in a transmit buffer. In this manner, even though the CIM 220 may have been generated in response to one data flow getting backed up and/or causing a buffer overflow, the information in the CIM 220 may be generalized and the NIC 212 may take appropriate action in regards to any affected or potentially affected data flows. In this manner, aspects of the invention may support scalability by allowing multiple flows to share limited resources, such as the ‘M’ hardware buffers 214, while also preventing congestion that affects a subset of the flows from impacting the remaining flows.

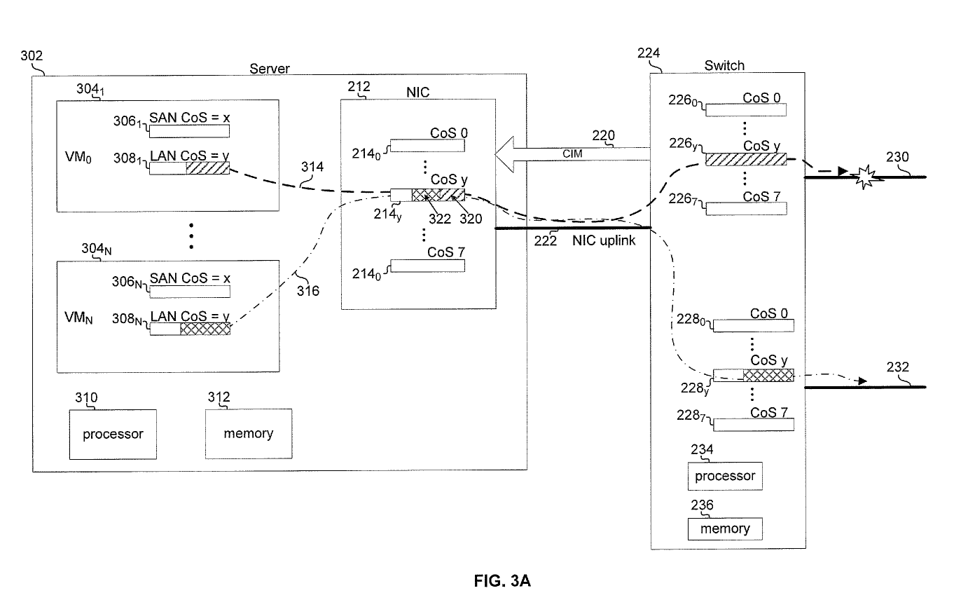

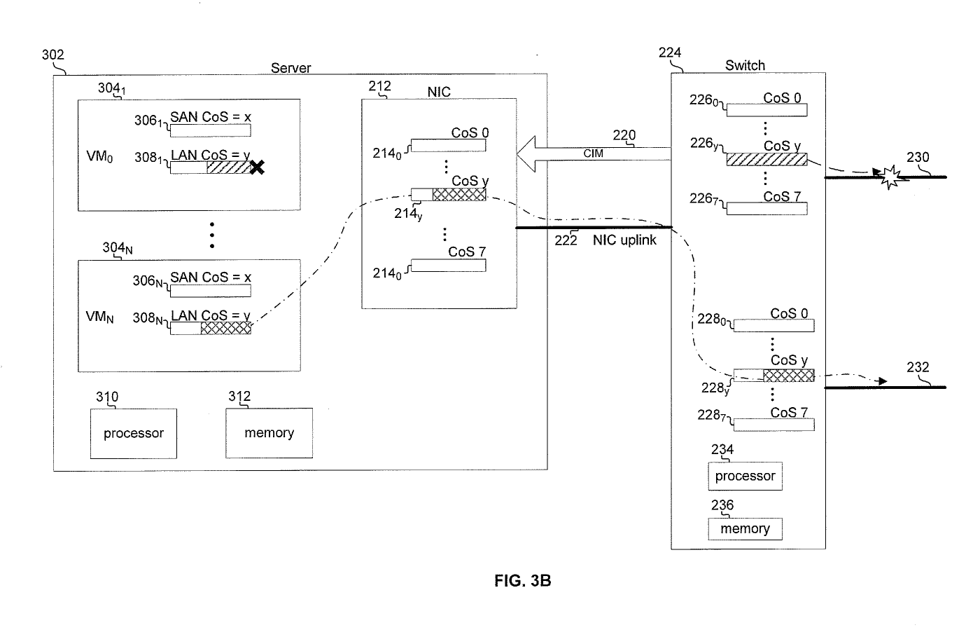

FIGS. 3A and 3B are diagrams illustrating path based congestion management for a server with virtualization, in accordance with an embodiment of the invention. Referring to FIGS. 3A and 3B there is shown a server 302, the NIC 212, and the switch 224.

The NIC 212 and the switch 224 may be as described with respect to FIGS. 2A and 2B. In this regard, aspects of the invention may enable preventing head of line blocking on the NIC 212 even when the server comprises a large number of virtual machines. Accordingly, buffering resources of the NIC 212 do not have to scale with the number of virtual machines running on the server 202. In some embodiments of the invention, the NIC 212 support single root input/output virtualization (SR IOV).

The server 302 may be similar to the server 202 described with respect to FIGS. 2A and 2B, but may differ in that the server 302 may comprise one or more virtual machines (VMs) 304₁, . . . , 304_{N}, collectively referenced as VMs 304. N may be an integer greater than or equal to one. The server 302 may comprise suitable logic, circuitry, and/or code that may be operable to execute software that implements the virtual machines 304. For example, the processor 310, utilizing the memory 312 may implement a hypervisor function for managing the VMs 304. In other embodiments of the invention, a hypervisor may be implemented in dedicated hardware not shown in FIGS. 3A and 3B

Each of the virtual machines 304 may comprise a software implementation of a machine such as a file or multimedia server. In this regard, a machine typically implemented with some form of dedicated hardware, may be realized in software on a system comprising generalized, multi-purpose, and/or generic, hardware. In this regard, the processor 310 and the memory 312 may be operable to implement the VMs 304.

In an exemplary embodiment of the invention, the server 302 may be communicatively coupled to a storage area network (SAN) and a local area network (LAN). Accordingly, each of the VMs 304 may comprise software buffers 306 for SAN traffic and buffers 308 for LAN traffic. Furthermore, SAN traffic may be associated with a CoS of ‘x,’ and LAN traffic may be associated with a CoS of ‘y,’ where ‘x’ and ‘y’ may each be any value from, for example, 0 to 7. In this manner, the VMs 304 may be operable to distinguish SAN traffic and LAN traffic such that, for example, one type of traffic or the other may be given priority and/or one type of traffic may be paused while the other is transmitted. The invention is not so limited to preclude the storage traffic or network traffic from being multiplexed by a hypervisor or to preclude the VMs 304 from interacting directly with the hardware. In this regard, the queues 306 may be managed by a Hypervisor, which may be implemented by the processor 110 or by dedicated hardware not shown in FIGS. 3A and 3B, or by the virtual machines 304.

In operation, the VM 304₁ may generate data flow 314 and VM 304_{N} may generate data flow 316. The data flows 314 and 316 may each have a CoS of ‘y,’ where ‘y’ may be, for example, from 0 to 7. In this regard, although 8 classes of service are utilized for illustration, the invention is not restricted to any particular number of classes of service.

A network path of the data flow 314 may comprise the NIC uplink 222, the switch 224, and the switch uplink 230. In this regard, data of data flow 314 may be queued in buffer 308₁ for conveyance to the NIC 212. The invention is not so limited to prevent some data or all of the data associated with buffer 308₁ to be stored on the NIC In the NIC 212, the data of data flow 314 may be queued in buffer 214_{y} for transmission to the switch 224. In the switch 224, the data of data flow 314 may be queued in buffer 226_{y} for transmission onto the switch uplink 230.

A network path of the data flow 316 may comprise the NIC uplink 222, the switch 224, and the switch uplink 232. In this regard, data of data flow 316 may be queued in buffer 308_{N} for conveyance to the NIC 212. The invention is not so limited to prevent some data or all of the data associated with buffer 308_{N} to be stored on the NIC. In the NIC 212, the data of data flow 316 may be queued in buffer 214_{y} for transmission to the switch 224. In the switch 224, the data of data flow 316 may be queued in buffer 228_{y} for transmission onto the switch uplink 232.

During operation, there may be congestion on the switch uplink 230 which may eventually cause the buffer 226y to become full. In a conventional system, this would prevent the data 320 belonging to data flow 314 from being transmitted from the NIC 212 to the switch 224. Consequently, the data 322, belonging to the data flow 316, queued behind the data 322, may also be prevented from being transmitted. Thus, head of line blocking would occur in a conventional system and would prevent the data flow 316 from being transmitted even though there is no congestion on the switch uplink 232 and no reason that the data flow 316 could not otherwise be successfully transmitted along its network path. Accordingly, aspects of the invention may prevent the congestion on the uplink 230 from blocking transmission of the data flow 316. In some embodiments of the invention, the NIC 212 support single root input/output virtualization (SR IOV).

In an exemplary embodiment of the invention, data of the data flow 314 may get backed up and eventually cause the buffer 226y to reach a “buffer full” threshold. Upon detecting the buffer 226y reaching such a threshold, the switch 224 may transmit a congestion indication message (CIM) 220 to the NIC 212. The CIM 220 may indicate that there is congestion on the switch uplink 230 for class of service ‘y’. Upon receiving the CIM 220, the NIC 212 may utilize its knowledge of the switch 224's routing algorithms and/or tables to determine which data flows have a path that comprises the uplink 230. In this manner, the NIC 212 may determine that the path of data flow 314 comprises switch uplink 230. Accordingly, the NIC 212 may pause transmission of the data flow 314 and may either clear the data 320 from the buffer 214_{y} or mark the data 320 as not ready for transmission so that it may be bypassed. In this manner, the data 322 and subsequent data of the data flow 316 may be transmitted to the switch 224. To pause the data flow 314, the NIC 212 may stop fetching data from the buffer 308₁ and/or convey one or more control signals and/or control messages to the VM 304₁. FIG. 3B illustrates the elimination of the head of line blocking in the buffer 214_{y} and the successful transmission of the data flow 316 after the data flow 314 has been paused and the data 320 cleared from the buffer 214_{y}.

Additionally, still referring to FIGS. 3A and 3B, pausing of the data flow 314 may comprise updating one or more fields of a path table, such as the path table 500 described below with respect to FIG. 5. In this regard, when a CIM is received by the NIC 212, the NIC 212 may determine data flows impacted by the congestion and may update the path table to indicate that the data flows are paused, or are to be transmitted at a reduced rate. When a virtual machine 304 desires to schedule the transmission of data associated with an existing data flow, the NIC 212 may consult its path table to determine whether the data flow is okay to transmit or whether it is paused. Similarly, when a virtual machine 304 desires to schedule the transmission of data associated with a new data flow, the NIC 212 may first determine, utilizing routing algorithms and/or tables of the switch 224, a path of the data flow and then may consult its path table to determine whether the path comprises any congested links or devices.

In various embodiments of the invention, one or more of the VMs 304₁, . . . , 304_{N} may generate more than one data flow that traverses the switch uplink 230. In such instance, each flow that traverses the switch uplink 230 and is of the affected class(es) of service may be paused—regardless of which VM 304 is the source of the data flows and regardless of whether a hypervisor is the source of the data flows. In this manner, even though the CIM 220 may have been generated in response to one data flow getting backed up and/or causing a buffer overflow, the information in the CIM 220 may be generalized and the NIC 212 may take appropriate action in regards to any affected or potentially affected data flows.

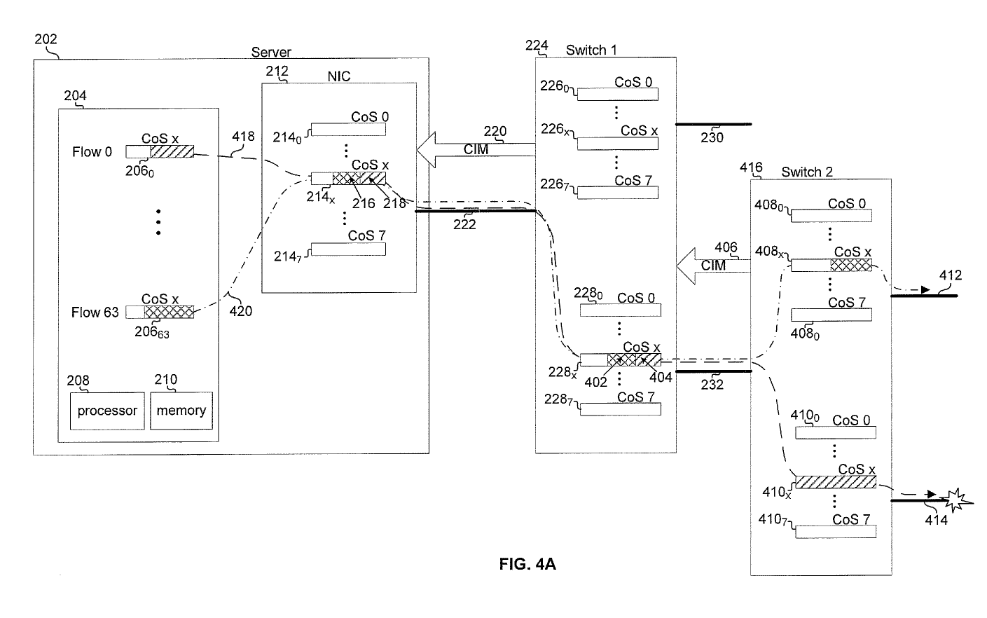

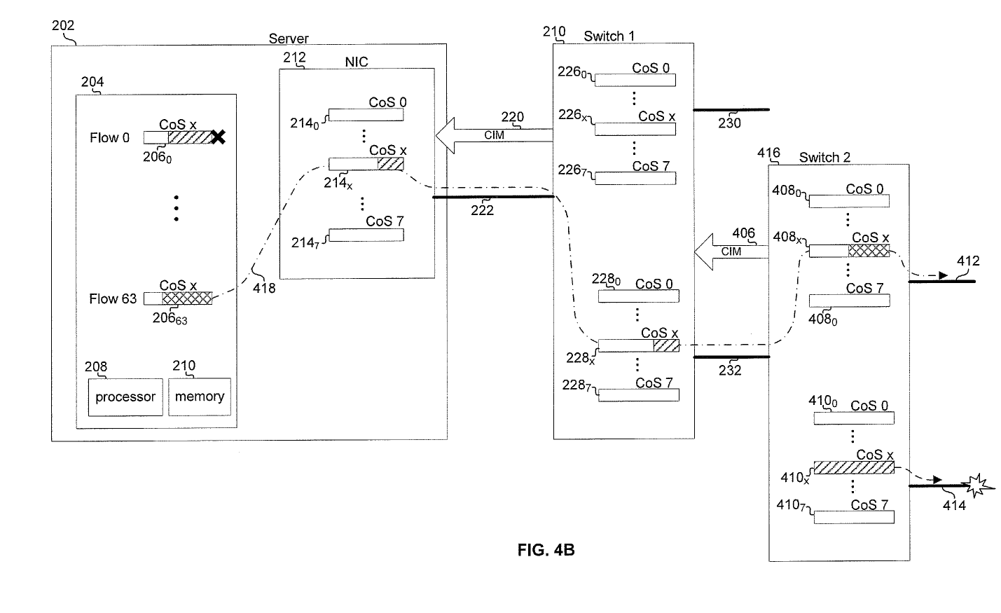

FIGS. 4A and 4B are diagrams illustrating path based congestion management over multiple network hops, in accordance with an embodiment of the invention. Referring to FIGS. 4A and 4B, there is shown a server 202, a first switch 210, and a second switch 416. The server 202, the NIC 212, and the first switch 224 may be as described with respect to FIGS. 2A and 2B. The second switch 416 may be substantially similar to the switch 224 described with respect to FIGS. 2A and 2B.

In operation, the server 202 may generate data flows 418 and 420. The data flows 418 and 420 may each have a CoS of ‘x,’ where ‘x’ may be, for example, from 0 to 7. In this regard, although 8 classes of service are utilized for illustration, the invention is not restricted to any particular number of classes of service.

A network path of the data flow 418 may comprise the NIC uplink 222, the switch 224, the switch uplink 232, the switch 416, and the switch uplink 414. In this regard, data of data flow 418 may be queued in buffer 206₀ for conveyance to the NIC 212. In the NIC 212, the data of data flow 418 may be queued in buffer 214ₓ for transmission to the switch 224. In the switch 224, the data of data flow 418 may be queued in buffer 228ₓ for transmission to the switch 416. In the switch 416, data of the data flow 418 may be queued in the buffer 410ₓ for transmission onto switch uplink 414.

A network path of the data flow 420 may comprise the NIC uplink 222, the switch 224, the switch uplink 232, the switch 416, and the switch uplink 412. In this regard, data of the data flow 420 may be queued in buffer 206₆₃ for conveyance to the NIC 212. In the NIC 212, the data of data flow 420 may be queued in buffer 214ₓ for transmission to the switch 224. In the switch 224, the data of data flow 420 may be queued in buffer 228ₓ for transmission to the switch 416. In the switch 416, data of the data flow 420 may be queued in the buffer 408ₓ for transmission onto switch uplink 412.

In an exemplary embodiment of the invention, there may be congestion on the path 414 and the switch 416 may generate a CIM 406 to notify upstream nodes of the congestion. The CIM 406 may be transmitted from the switch 416 to the switch 224. The switch 224 may forward the CIM 416 along with other CIMs, if any, and may also add its own info to allow the NIC 212 to determine the complete or partial network path generated by the switch 224. In this regard, the CIM 220 transmitted to the NIC 212 may identify multiple congestion points in the network.

In various embodiments of the invention, the NIC 212 may comprise knowledge of the routing algorithms and/or tables utilized by both switches 224 and 416. In instances that the NIC stores forwarding or routing tables, memory required by the NIC 212 may become prohibitively large as the number of switches increases. However, if both switches 224 and 416 utilize a same or similar routing algorithm, determination of network paths by the NIC 212 may be straightforward and may be performed without requiring large amounts of additional memory. Alternatively, the NIC 212 may maintain a partial knowledge of the network topology and still improve the overall network performance by generalizing the info received via one or more CIMs and globalizing that information to the relevant flows.

Control and scheduling of data flows by the NIC 212 in FIGS. 4a and 4b may proceed in a manner similar to that described with respect to FIGS. 2A and 2B. In this regard, flows that traverse congested links may be paused by the NIC 212 and data may be removed from buffers in the NIC 212 and in one or both of the switches 224 to prevent head of line blocking. In this regard, FIG. 4B illustrates the data flow 418 having been paused to prevent exacerbating the congestion on the uplink 414 and to enable transmission of the data flow 420 which is not congested.

FIG. 5 illustrates a portion of an exemplary path table that may be utilized for path based network congestion management, in accordance with an embodiment of the invention. Referring to FIG. 5, there is shown an exemplary path table 500 for the NIC 212 of FIGS. 2A and 2B. The path table 500 may comprise entries 512₀, . . . , 512₆₃ corresponding to data flows 0 to 63, collectively referenced as entries 512. Each entry 512 may comprise a flow ID field 502, a switch field 504, switch uplink field 506, a Cos field 508, and a status field 510. In some embodiments of the invention, an index of an entry 512 in the path table 500 may be used instead of or in addition to the flow ID field 502.

The flow ID field 502 may distinguish the various flows generated by the server 202. In an exemplary embodiment of the invention, the server 202 may support 64 simultaneous data flows and the data flows may be identified by numbering them from 0 to 63. In other embodiments of the invention, the flows may be identified by, for example, their source address and destination address.

The switch field 504 may identify a switch communicatively coupled to the NIC 212 via which the data flow may be communicated. In this regard, a multi-port NIC may be communicatively coupled to multiple switches via multiple NIC uplinks 222. The switch may be identified by, for example, its network address, a serial number, or a canonical name assigned to it by a network administrator.

The switch uplink filed 506 may identify which uplink of the switch identified in field 504 that the data path may be forwarded onto.

The CoS field 508 may identify a class of service associated with the data flow. In an exemplary embodiment of the invention, the CoS may be from 0 to 7.

The status field 510 may indicate whether a data flow may be scheduled for transmission or is paused. The status field 510 may be updated based on received congestion indication messages and based on one or more time parameters which determine how long information received in a CIM is to remain valid. In some embodiments of the invention, the status field 510 may indicate a data rate at which a data flow may be communicated.

In operation, the NIC 212 may populate the path table 500 based on inspection of data flows transmitted by the server 202, CIMs received from the switch 224, and/or forwarding or routing tables and/or algorithms of the switch 224. In various embodiments of the invention, the forwarding or routing tables and/or algorithms may be obtained via configuration by a network administrator, via one or more dedicated messages communicated from the switch to the NIC, or via information appended to CIMs or other packets transmitted from the switch 224 to the NIC 212.

Generation of the path table 500, utilizing the forwarding table and/or algorithm of the switch 110, may require significant processing time and/or processing resources. Accordingly, the path table 500 may be generated in the processing sub-system 204 and then transferred to the NIC 212. Once the path table 500 is generated, the NIC 212 may be operable to retrieve data and update the status field 510 in real-time. In the case of a single hop—a NIC 212 with its adjacent switch, for example—generation of the path table may be significantly simpler. In particular, generation of the path table may be relatively simple when the switch is configured to use a simple hash function to choose an uplink for incoming flows. For example, the TCP/IP four-tuple may be hashed.

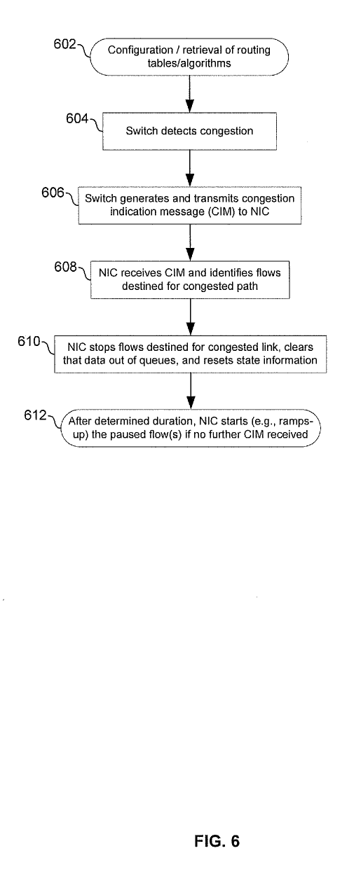

FIG. 6 is a flow chart illustrating exemplary steps for path based network congestion management, in accordance with an embodiment of the invention. For illustration, the steps are described with respect to FIGS. 2A and 2B. Referring to FIG. 6 the exemplary steps may begin with step 602 when the NIC 212 may be configured to be operable to perform path based congestion management. In various embodiments of the invention, parameters such as how many flows the NIC 212 may handle, buffer sizes, buffer thresholds, and information about network topology may be configured in the NIC 212 by a network administrator and/or determined via the exchange of messages between the NIC 212 and the switch 224. In various embodiments of the invention, one or more time parameters in the NIC 212 utilized for determining how long to pause a data flow may be configured. In various embodiments of the invention, a forwarding or routing table and/or algorithms utilized by the switch 224 may be communicated to the NIC 212 and/or entered in the NIC 212 by a network administrator. In various embodiments of the invention, the path table 500 may be generated in the processing subsystem 204 prior to the server 202 beginning to generate data flows. Subsequent to step 602, the exemplary steps may advance to step 604.

In step 604, the switch 224 may detect congestion on one of its uplinks. In various embodiments of the invention, the switch 224 may detect the congestion on an uplink, and which class(es) of service are affected by the congestion, based on a status of one or more of the NIC 224's buffers, based on control or network management messages communicated via the uplink, and/or based on roundtrip delays on the uplink. Subsequent to step 604, the exemplary steps may advance to step 606.

In step 606, the switch 224 may generate a congestion indication message (CIM) and transmit the CIM to the NIC 212. In various embodiments of the invention, the CIM 212 may be transmitted as a dedicated message or may be appended to other messages transmitted to the NIC 212. The CIM may be operable to identify an uplink or switch port via which the congestion was detected. The CIM may comprise a source and destination address of traffic that experienced the congestion. Subsequent to step 606, the exemplary steps may advance to step 608.

In step 608, the NIC 212 may receive the CIM generated in step 606. The NIC 212 may identify the flow based on, for example, its source address, destination address, and class of service. The NIC 212 may look-up or otherwise determine the identified flow in the path table to determine its path and to determine with switch uplink it traverses. Accordingly, the NIC 212 may then utilize the path table to identify flows belonging to the same class of service that traverse the congested uplink. Subsequent to step 608, the exemplary steps may advance to step 610.

In step 610, the NIC may pause or slow down flows that traverse the congested uplink. Additionally, the NIC 212 may clear data belonging to flows that traverse the congested uplink from its transmit buffers. Additionally, the NIC 212 may reset one or more variables or registers to a state prior to the queuing of such data. In this regard, state variables may be “rewound” such that the transmission of the cleared data may be scheduled for a later time and the data may not be lost or dropped completely. Similarly, the processing subsystem 204 may “rewind” a state of one or more variables or software functions. Subsequent to step 610, the exemplary steps may advance to step 612.

In step 612, after the one or more data flows have been paused for a duration of time, the NIC 212 may update the flow table to enable scheduling of the data flows for transmission and may signal to the processing subsystem 204 that queuing of the data flows may resume. In this regard, the duration of time may be determined based on, for example, a configuration by a network administrator. Additionally, the duration of time may be contingent on no further CIMs affecting those data flows being received.

Aspects of a method and system for path based network congestion management are provided. In an exemplary embodiment of the invention, a network device 102 may determine, based on an indication 118 of a network condition encountered by a data flow 106, which of a plurality of data flows, such as the data flow 106, are affected by the network condition. The network device 102 may identify one or more network paths, such as paths comprising the uplink 114, associated with said plurality of data flows affected by the network condition. The network device 102 may update the contents of a table to reflect the status of the one or more network paths associated with the plurality of data flows. The indication 118 may be received from a second network device 110. Transmission of the first data flow 106 and/or other data flows of the plurality of data flows may be managed based on the determination and the indication. The network device 102 may determine which of the plurality of data flows is affected by the network condition based on a class of service associated with each of the plurality of data flows. The network device 102 may schedule transmission of one or more of the plurality of data flows based on the determination and the identification. The table may comprise information indicating which, if any, of the plurality of data flows is affected by the network condition. The one or more paths, such as paths comprising the uplink 114, associated with the plurality of data flows are determined based on one or both of a forwarding table and/or a forwarding algorithm of a downstream network device 110.

In an exemplary embodiment of the invention, the network device 202 may allocate a number of buffers 214 for storing a number of data flows, where the number of buffers 214 is less than the number of data flows. The network device 202 may manage data stored in the buffers 214 based on an indication of a network condition encountered by one or more of the data flows. Data stored in the buffers may be managed by removing, from one or more of the buffers, data associated with one or more of the data flows that are to be transmitted to a part of the network affected by the network condition. Data affected by the network condition and stored in one or more buffers 214 may be marked, and unmarked data stored in the buffers 214 may be transmitted before the marked data, even if the unmarked data was stored in the buffers 214 after the marked data. The data flows may be associated with a set of service classes and each of the one or more buffers may be associated with a subset of the set of service classes.

In an exemplary embodiment of the invention, a network device 202 may receive information about network path selection from a second network device 224 communicatively coupled to the first network device 202. The first network device 202 may schedule data for transmission based on the received information; and may transmit data according to the scheduling. The received information may comprise one or both of: at least a portion of a forwarding table utilized by the second network device 224, and information pertaining to an algorithm the second network device 224 uses to perform path selection. A path for communicating one or more data flows may be selected based on said received information. An indication as to which network path to use for communicating one or more data flows may be communicated from the first network device 202 to the second network device 224.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for path based network congestion management.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for networking, the method comprising:
performing via one or more circuits in a network device:
determining, based on an indication of a network condition encountered by a first of a plurality of data flows, which of said plurality of data flows is affected by said network condition;
identifying one or more network paths associated with said plurality of data flows affected by said network condition; and
updating contents of a table to reflect the status of said one or more network paths associated with said plurality of data flows.

2. The method according to claim 1, wherein said indication is received from a second network device.

3. The method according to claim 1, comprising managing transmission of said first data flow and/or other data flows of said plurality of data flows based on said determination and said indication.

4. The method according to claim 1, comprising determining which of said plurality of data flows is affected by said network condition based on a class of service associated with each of said plurality of data flows.

5. The method according to claim 1, comprising scheduling transmission of one or more of said plurality of data flows based on said determination and said identification.

6. The method according to claim 1, wherein said table comprises information indicating which, if any, of said plurality of data flows is affected by said network condition.

7. The method according to claim 1, wherein said one or more paths associated with said plurality of data flows is determined based on one or both of a forwarding table and/or a forwarding algorithm of a downstream network device.

8. A method for networking, the method comprising:
performing via one or more circuits in a network device:
allocating a number of buffers for storing a number of data flows, where said number of buffers is less than said number of data flows; and
managing data stored in said buffers based on an indication of a network condition encountered by one or more of said data flows.

9. The method according to claim 8 comprising, managing said data stored in said buffers by removing, from one or more of said buffers, data associated with one or more of said data flows that are to be transmitted to a part of said network affected by said network condition.

10. The method according to claim 8, comprising:
marking data affected by said network condition; and
transmitting unmarked data before said marked data, even if said unmarked data was stored in said buffers after said marked data.

11. The method according to claim 8, wherein said data flows are associated with a set of service classes and each of said one or more of said buffers are associated with a subset of said set of service classes.

12. A method for networking, the method comprising:
performing by one or more circuits in a first network device:
receiving information about network path selection from a second network device communicatively coupled to said first network device;
scheduling data for transmission based on said received information; and
transmitting said data according to said scheduling.

13. The method according to claim 12, wherein said received information comprises one or both of:
at least a portion of a forwarding table utilized by said second network device; and/or
information pertaining to an algorithm said second network device uses to perform said path selection.

14. The method according to claim 12, comprising selecting a path for communicating one or more data flows based on said received information.

15. The method according to claim 14, comprising communicating, to said second network device, an indication as to which network path to use for communicating one or more data flows.

16. A system for networking, the system comprising:
one or more circuits for use in a network device, said one or more circuits being operable to:
determine, based on an indication of a network condition encountered by a first of a plurality of data flows, which of said plurality of data flows is affected by said network condition; and
identify one or more network paths associated with said plurality of data flows affected by said network condition; and
update contents of a table to reflect the status of said one or more network paths associated with said plurality of data flows.

17. The system according to claim 16, wherein said indication is received from a second network device.

18. The system according to claim 16, wherein said one or more circuits are operable to manage transmission of said first data flow and/or other data flows of said plurality of data flows based on said determination and said indication.

19. The system according to claim 16, wherein said one or more circuits are operable to determine which of said plurality of data flows is affected by said network condition based on a class of service associated with each of said plurality of data flows.

20. The system according to claim 16, wherein said one or more circuits are operable to schedule transmission of one or more of said plurality of data flows based on said determination and said identification.

21. The system according to claim 16, wherein said table comprises information indicating which, if any, of said plurality of data flows is affected by said network condition.

22. The system according to claim 16, wherein said one or more paths associated with said plurality of data flows is determined based on one or both of a forwarding table and/or a forwarding algorithm of a downstream network device.

23. A system for networking, the system comprising:
one or more circuits for use in a network device, said one or more circuits being operable to:
allocate a number of buffers for storing a number of data flows, where said number of buffers is less than said number of data flows; and
manage data stored in said buffers based on an indication of a network condition encountered by one or more of said data flows.

24. The system according to claim 23 comprising, wherein said one or more circuits are operable to manage said data stored in said buffers by removing, from one or more of said buffers, data associated with one or more of said data flows that are to be transmitted to a part of said network affected by said network condition.

25. The system according to claim 23, wherein said one or more circuits are operable to:
mark data affected by said network condition; and
transmit unmarked data before said marked data, even if said unmarked data was stored in said buffers after said marked data.

26. The system according to claim 23, wherein said data flows are associated with a set of service classes and each of said one or more of said buffers are associated with a subset of said set of service classes.

27. A system for networking, the system comprising:
one or more circuits for use in a first network device, said one or more circuits being operable to:
receive information about network path selection from a second network device communicatively coupled to said first network device;
schedule data for transmission based on said received information; and
transmit said data according to said scheduling.

28. The system according to claim 27, wherein said received information comprises one or both of:
at least a portion of a forwarding table utilized by said second network device; and/or
information pertaining to an algorithm said second network device uses to perform said path selection.

29. The system according to claim 27, wherein said one or more circuits are operable to select a path for communicating one or more data flows based on said received information.

30. The system according to claim 29, wherein said one or more circuits are operable to communicate, to said second network device, an indication as to which network path to use for communicating one or more data flows.
